(19) United States
(12) Patent Application Publication
(10) Pub. No.: US 2015/0370394 A1
(43) Pub. Date: Dec. 24, 2015

(54) SENSING STRUCTURE OF ONE-GLASS SOLUTION (OGS) TOUCH PANEL

(71) Applicant: CANDO CORPORATION, Hsinchu County (TW)

(72) Inventors: Te-Lung Cheng, Hsinchu County (TW); Ping-Chung Hsueh, Hsinchu County (TW); Shih-Ming Tsao, Hsinchu County (TW)

(21) Appl. No.: 14/733,967

(22) Filed: Jun. 9, 2015

(30) Foreign Application Priority Data
Jun. 18, 2014 (TW) 103210695

(51) Int. Cl. G06F 3/041; G06F 1/16

(52) U.S. Cl. CPC G06F 3/0412; G06F 1/16; G06F 2203/04103; G06F 2203/04111; G06F 2203/04107

(57) ABSTRACT

A sensing structure of a one-glass solution (OGS) touch panel is provided, which has a designed diversion structure, such that an electrostatic discharge (ESD) protection capability of the sensing structure is improved. According to such design, the ESD protection capability of the sensing structure is improved without increasing a process complexity, so as to avoid energy release of electrostatic charges to cause a damage of the sensing structure.

### CROSS-REFERENCE TO RELATED APPLICATION

This application claims the priority benefit of Taiwan application serial no. 103210695, filed on Jun. 18, 2014. The entirety of the above-mentioned patent application is hereby incorporated by reference herein and made a part of this specification.

### BACKGROUND OF THE INVENTION

1. Field of the Invention

The invention relates to a sensing structure of a one-glass solution (OGS) touch panel, and particularly relates to a sensing structure of an OGS touch panel having an improved electrostatic discharge (ESD) protection capability.

2. Description of Related Art

Along with diversification and popularity of various electronic products capable of implementing human-machine interaction through a screen, such as smart phones, tablet personal computers (PCs), touch navigation systems, etc., demand on touch screen is highly increased. Through the touch screen, the electronic products may have human-machine interfaces that are easy to be operated, and a user can intuitively operate and confirm a display content of the screen by using a finger or other objects, and such electronic products are widely praised by the users.

The touch screen is mainly composed of a touch panel and a liquid crystal display (LCD) module. In various structure designs of the touch panel, a one-glass solution (OGS) touch panel integrates a glass substrate (i.e. a glass covering mirror) and a conductive layer (or referred to as “touch sensing layer”), i.e. by plating a touch sensing layer composed of a high-impedance transparent conductive material such as AZO, ITO, GZO or IZO, etc., on an inner side of the glass substrate, plating, patterning and etching processes are directly performed on the glass substrate to form the OGS touch panel. In view of a manufacturing process, since a piece of glass and an adhesion step are omitted, the cost of the OGS touch panel is decreased, and the OGS touch panel is more in line with a development trend of light and thin of the electronic product, so that it has become an application mainstream of the touch screen.

Referring to FIG. 1, FIG. 1 is a partial top view of a sensing structure of a one-glass solution (OGS) touch panel of a conventional technique. The sensing structure 10 of the conventional OGS touch panel includes a glass substrate 100 and a sensing layer formed on the glass substrate 100, where the sensing layer has a plurality of first sensing units 110 and a plurality of second sensing units 120. The sensing layer is patterned in a manner that the first sensing units 110 are electrically connected to each other through a first neck region 115 along a first direction (for example, an x-axis direction shown in FIG. 1), and the second sensing units 120 are electrically connected to each other through a second neck region 125 along a second direction (for example, a y-axis direction shown in FIG. 1). The first sensing units 110 and the second sensing units 120 are electrically isolated.

Generally, in view of a manufacturing process of the conventional structure shown in FIG. 1, a black photoresist layer is first coated on the glass substrate to form a decoration pattern, and a transparent conductive layer (for example, ITO, AZO, GZO, or IZO, etc.) is sputtered thereon and processed into a purposeful pattern to create an electric field characteristic. In other words, the sensing layer of the OSG touch panel is formed by patterning a transparent conductive layer, i.e. the sensing units and the neck regions in the sensing layer are all made of a transparent conductive material (for example, ITO, AZO, GZO, or IZO, etc.). Under such design, since the relatively narrow neck regions formed between the sensing units are all made of the high-impedance transparent conductive layer, when a current flows through the conductor, a current density at the narrow neck region is increased to produce an electrostatic discharge (ESD) phenomenon, and the conductor and the sensing units are probably damaged due to the energy release.

Presently, although a circle of metal grounding wire with a wider line width can be formed around the sensing layer to mitigate the ESD phenomenon, such solution still requires an additional manufacturing process, which results in higher complexity and cost.

### SUMMARY OF THE INVENTION

Due to the aforementioned reasons, the invention provides a sensing structure of a one-glass solution (OGS) touch panel. The sensing structure of the invention has improved ESD protection capability. Moreover, since the sensing structure of the invention is not complicated in structure, it can be implemented through a manufacturing process with a low cost and low complexity.

A first exemplary embodiment of the invention provides a sensing structure of a one-glass solution (OGS) touch panel, which includes a substrate and a sensing layer formed on one side of the substrate, where the sensing layer has a plurality of first sensing units and a plurality of second sensing units, the first sensing units are electrically connected to each other through a first neck region along a first direction, and the second sensing units are electrically connected to each other through a second neck region along a second direction, where the first sensing units and the second sensing units are electrically isolated, and the first direction is different to the second direction. The sensing structure further includes a diversion structure layer, which is composed of a plurality of diversion structures, where each of the diversion structures is independent to each of the first neck regions and is coupled between the first sensing units, and has an impedance smaller than that of the first neck region.

In the first exemplary embodiment of the invention, the diversion structures are first diversion structures, and the diversion structure layer further includes a plurality of second diversion structures, where each of the second diversion structures is independent to each of the second neck regions and is coupled between the second sensing units, and has an impedance smaller than that of the second neck region.

In the first exemplary embodiment of the invention, the sensing layer is formed by patterning a transparent conductive layer, and the transparent conductive layer may include at least one of AZO, ITO, GZO and/or IZO.

In the first exemplary embodiment of the invention, the first sensing units, the second sensing units, the first neck regions and the diversion structures in the sensing layer are formed by patterning a transparent conductive layer.

In the first exemplary embodiment of the invention, the first sensing units, the second sensing units and the first neck regions in the sensing layer are formed by patterning a transparent conductive layer, and the diversion structure layer is a patterned metal layer.

A second exemplary embodiment of the invention provides a sensing structure of an OGS touch panel, which includes a substrate and a sensing layer formed on one side of the substrate. The sensing layer has a plurality of first sensing units and a plurality of second sensing units, where the first sensing units are electrically isolated with the second sensing units, and the first sensing units are electrically connected to each other through a first neck region along a first direction. The sensing structure further includes a bridge structure layer, which has a plurality of bridge structures, and the bridge structures are respectively coupled between the second sensing units, such that the second sensing units are electrically connected to each other along a second direction, where the second direction is different to the first direction.

In the second exemplary embodiment of the invention, the sensing layer is formed by patterning a transparent conductive layer, and the transparent conductive layer includes at least one of AZO, ITO, GZO and/or TZO.

In the second exemplary embodiment of the invention, the first sensing units, the second sensing units and the neck regions in the sensing layer are formed by patterning a transparent conductive layer, and the bridge structure layer is a patterned metal layer.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a partial top view of a sensing structure of a one-glass solution (OGS) touch panel of a conventional technique.

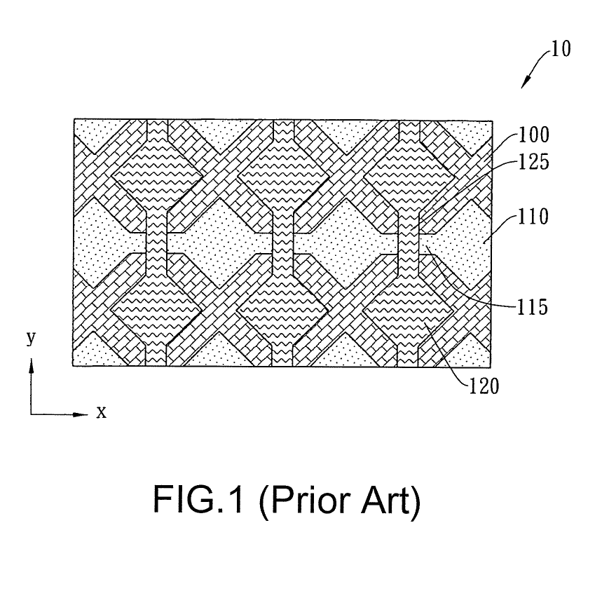

FIG. 2 is a partial top view of a sensing structure of an OGS touch panel according to a first exemplary embodiment of the invention.

FIG. 3 is a partial top view of a sensing structure of an OGS touch panel according to a second exemplary embodiment of the invention.

### DESCRIPTION OF EMBODIMENTS

In order to make the aforementioned and other features and advantages of the invention comprehensible, several exemplary embodiments accompanied with figures are described in detail below. It should be noticed that the following descriptions and figures are only schematic and used for assisting understanding of the invention, and are not necessarily dawn to scale and to have a precise configuration. Therefore, a range of the claims of the invention should not be interpreted according to proportions and configuration relationships of the figures, and the range of the invention is defined by the claims listed below.

The embodiments of the invention are described below with reference of figures. It should be noticed that the components indicated in the figures are only used for description clarity, and do not represent actual sizes and proportions. Moreover, for simplicity's sake, drawn and description of the conventional components are omitted in a part of the figures.

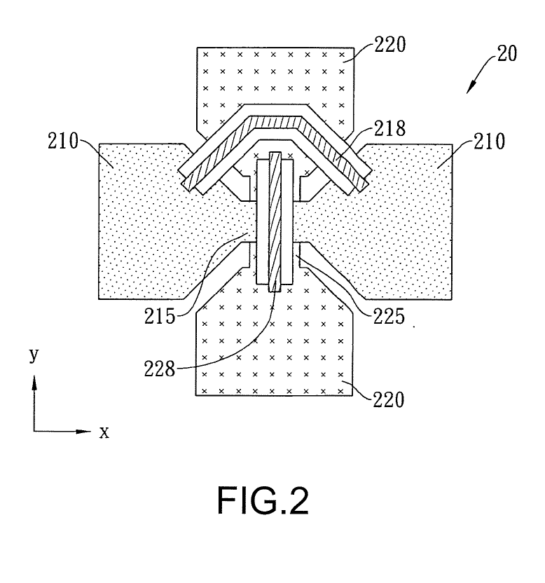

Referring to FIG. 2, FIG. 2 is a partial top view of a sensing structure of a one-glass solution (OGS) touch panel according to a first exemplary embodiment of the invention. In the present embodiment, the sensing structure 20 of the OGS touch panel is a sensing layer foamed on one side of a glass substrate by patterning a transparent conductive layer, and the sensing layer includes a plurality of first sensing units 210, a plurality of second sensing units 220 and corresponding neck regions 215 and 225 after patterning. A first neck region 215 with a narrow width is connected between each two adjacent first sensing units 210, such that the first sensing units 210 are electrically connected to each other along a first direction (for example, an x-axis direction shown in FIG. 2), and the second sensing units 220 are electrically connected to each other through a second neck region 225 along a second direction (for example, a y-axis direction shown in FIG. 2). The first sensing units 210 and the second sensing units 220 are electrically isolated. Manufacturing processes and configurations of the sensing units 210, 220 and the neck regions 215 and 225 are known by those skilled in the art, so that details thereof are not repeated, so as to avoid confusing the concept and spirit of the invention.

Generally, the neck region is a narrow region formed between the sensing units. In the present embodiment, in order to avoid accumulation of electrostatic charges at the neck regions to cause energy release to damage the sensing units, diversion structures 218 and 228 are respectively configured between the sensing units of each direction (i.e. between the first sensing units 210 along the x-axis direction of FIG. 2 and between the second sensing units 220 along the y-axis direction of FIG. 2), so as to respectively diverge the electrostatic charges possibly accumulated at the first neck region 215 and the second neck region 225. According to the present embodiment of the invention, the diversion structures 218 and 228 are formed by patterning an independent metal material layer (for example, a metal material layer of aluminium, copper, silver, etc.) with impedance smaller than that of the sensing units and the neck regions, and are disposed on the sensing layer in a whole-piece alignment manner. Moreover, the diversion structures 218 and 228 form a diversion structure layer of the sensing structure 20.

It should be noticed that the configuration shown in FIG. 2 is only an example, and based on the teachings of the present embodiment, the diversion structure may be selectively configured in a single direction (for example, the x-axis direction or the y-axis direction), or in two different directions (i.e. the x-axis direction and the y-axis direction), so as to implement charge diversion for the corresponding neck regions.

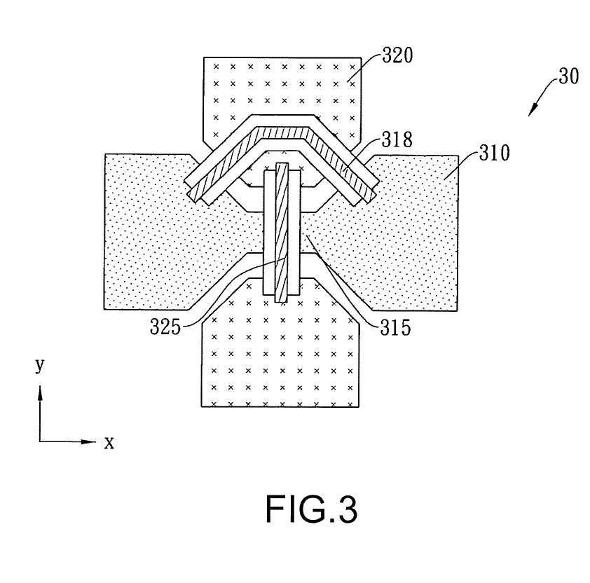

Referring to FIG. 3, FIG. 3 is a partial top view of a sensing structure of an OGS touch panel according to a second exemplary embodiment of the invention. As described above, the sensing structure 30 of the OGS touch panel is a sensing layer formed on one side of a glass substrate by patterning a transparent conductive layer, and the sensing layer includes a plurality of first sensing units 310, a plurality of second sensing units 320 and corresponding neck regions 315 after patterning. Different to the first exemplary embodiment, in the embodiment of FIG. 3, the first sensing units 310 are also connected by the first neck regions 315 with a narrow width and formed by patterning the sensing layer, such that the first sensing units 310 are electrically connected to each other along the first direction (for example, the x-axis direction shown in FIG. 3). However, a bridge structure 325 is connected between each two adjacent second sensing units 320 along the second direction (for example, the y-axis direction shown in FIG. 3), and such bridge structures 325 form a bridge structure layer of the sensing structure 30. In the present embodiment, the sensing layer is, for example, formed by a transparent conductive layer (for example, ITO, AZO, GZO, or IZO, etc.) plated on the glass substrate. In other words, the sensing units 310 and 320 and the neck region 315 is formed by patterning the transparent conductively layer. Manufacturing processes and configurations of the sensing units 310, 320, the neck regions 315 and the bridge structures 325 bridging between the second sensing units 320 are known by those skilled in the art, so that details thereof are not repeated, so as to avoid confusing the concept and spirit of the invention.

As described above, the first neck regions 315 are formed between the sensing units 310. In the present embodiment, in order to avoid accumulation of electrostatic charges at the neck regions 315 to cause energy release to damage the sensing units 310, a diversion structure 318 is configured between the sensing units 310 along the x-axis direction of FIG. 3, so as to diverge the electrostatic charges possibly accumulated at the corresponding first neck region 315. According to the present embodiment of the invention, the diversion structures 318 are formed by patterning an independent metal material layer (for example, a metal material layer of aluminium, copper, silver, etc.) with impedance smaller than that of the sensing units and the neck regions, and such diversion structures 318 similarly form a diversion structure layer of the sensing structure 30. Moreover, the diversion structures 318 and the bridge structures 325 connected between the second sensing units 320 can be simultaneously formed by patterning an independent metal layer, and are then disposed on the sensing layer in a whole-piece alignment manner, so as to decrease a process complexity. It is noted that, in the other exemplary embodiment, the sensing structure 30 of the second exemplary embodiment can be modified. For example, each two adjacent first sensing units 310 can be changed to be connected through the bridge structure (similarly to 325) along the x-axis direction shown in FIG. 3; and on the other hand, each two adjacent second sensing units 320 can be changed to be connected by the corresponding neck region with a narrow width and formed by patterning the sensing layer, such that the second sensing units 320 are electrically connected to each other along the y-axis direction shown in FIG. 3.

The aforementioned exemplary embodiments are only examples of the sensing structure of the OGS touch panel of the invention, in an actual application, the sensing structure is not limited to includes the aforementioned characteristics only. For example, the sensing structure may further include (but not limited to) a passivation layer, a color filter layer, a black matrix (BM) layer, or other optical layers according to an actual requirement, and the glass substrate in the sensing structure can be a tempered glass substrate after an enhancement processing or includes other optical processing layers.

The diversion structure layer of the invention is made of a metal material (such as aluminium, copper, silver, etc.) with impedance smaller than that of the transparent conductive layer, which can be formed by an independent pattern layer. Alternatively, in the implementation that the bridge structures are applied, the diversion structure and the bridge structures bridging between the sensing units are formed together, and are disposed on the sensing layer in a whole-piece alignment manner. In this way, the ESD protection capability of the sensing structure is improved without increasing a process complexity, so as to avoid energy release of the electrostatic charges to cause a damage of the sensing structure. The invention is a novel and advanced invention, and has industrial practicality and competitiveness, which has a deep development value.

It should be noticed that all of the characteristics disclosed in the specification can be combined with other methods or structures, and each characteristic disclosed in the specification can be selectively replaced by a same, equivalent or similar objective characteristic. Therefore, besides the most significant characteristics, all of the characteristics disclosed in the specification of the invention are only an example of the equivalent or similar characteristics.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A sensing structure of a one-glass solution touch panel, comprising:
a substrate; and
a sensing layer, formed on one side of the substrate, the sensing layer having a plurality of first sensing units and a plurality of second sensing units, the first sensing units being electrically connected to each other through a first neck region along a first direction, and the second sensing units being electrically connected to each other through a second neck region along a second direction, wherein the first sensing units and the second sensing units are electrically isolated, and the first direction is different to the second direction; and
a diversion structure layer, comprising a plurality of diversion structures, wherein each of the diversion structures is independent to each of the first neck regions and is coupled between the first sensing units, and has an impedance smaller than that of the first neck region.

2. The sensing structure of the one-glass solution touch panel as claimed in claim 1, wherein the diversion structures are first diversion structures, and the diversion structure layer further comprises a plurality of second diversion structures, wherein each of the second diversion structures is independent to each of the second neck regions and is coupled between the second sensing units, and has an impedance smaller than that of the second neck region.

3. The sensing structure of the one-glass solution touch panel as claimed in claim 1, wherein the sensing layer is formed by patterning a transparent conductive layer.

4. The sensing structure of the one-glass solution touch panel as claimed in claim 3, wherein the transparent conductive layer comprises at least one of AZO, ITO, GZO and/or IZO.

5. The sensing structure of the one-glass solution touch panel as claimed in claim 1, wherein the first sensing units, the second sensing units, the first neck regions and the diversion structures in the sensing layer are formed by patterning a transparent conductive layer.

6. The sensing structure of the one-glass solution touch panel as claimed in claim 1, wherein the first sensing units, the second sensing units and the first neck regions in the sensing layer are formed by patterning a transparent conductive layer, wherein the diversion structure layer is a patterned metal layer.

7. A sensing structure of a one-glass solution touch panel, comprising:
a substrate;
a sensing layer, formed on one side of the substrate, the sensing layer having a plurality of first sensing units and a plurality of second sensing units, wherein the first sensing units are electrically isolated with the second sensing units, and the first sensing units are electrically connected to each other through a first neck region along a first direction;
a bridge structure layer, comprising a plurality of bridge structures, and the bridge structures being respectively coupled between the second sensing units, such that the second sensing units are electrically connected to each other along a second direction, wherein the second direction is different to the first direction; and
a diversion structure layer, comprising a plurality of diversion structures, wherein each of the diversion structures is independent to each of the first neck regions and is coupled between the first sensing units, and has an impedance smaller than that of the first neck region.

8. The sensing structure of the one-glass solution touch panel as claimed in claim 7, wherein the sensing layer is formed by patterning a transparent conductive layer.

9. The sensing structure of the one-glass solution touch panel as claimed in claim 8, wherein the transparent conductive layer comprises at least one of AZO, ITO, GZO and/or IZO.

10. The sensing structure of the one-glass solution touch panel as claimed in claim 7, wherein the first sensing units, the second sensing units and the neck regions in the sensing layer are formed by patterning a transparent conductive layer, wherein the bridge structure layer is a patterned metal layer.
